(19) United States
(12) Patent Application Publication
(10) Pub. No.: US 2024/0149493 A1
(43) Pub. Date: May 9, 2024

(54) CONCRETE PANEL ASSEMBLY SYSTEM AND METHOD OF USE THEREOF

(71) Applicant: Innovatech Systems, LLC, Kanarraville, UT (US)

(72) Inventors: James Barlow, Kanarraville, UT (US); James Harker, Kanarraville, UT (US)

(73) Assignee: Innovatech Systems, LLC, Kanarraville, UT (US)

(21) Appl. No.: 18/501,567

(22) Filed: Nov. 3, 2023

Related U.S. Application Data
(60) Provisional application No. 63/382,230, filed on Nov. 3, 2022.

(51) Int. Cl. B28B 23/02; E04B 2/00; E04C 2/06

(52) U.S. Cl. CPC B28B 23/024; E04C 2/06; E04C 2/46

(57) ABSTRACT

A concrete panel assembly system features a panel casting apparatus, a panel trailer, and a divider trailer. The panel casting apparatus includes two outer forms that surround a plurality of dividers and concrete receiving inserts. The concrete receiving inserts are custom assembled at an offsite factory and transported to the jobsite without concrete. A conveyor then moves a concrete hopper from one side of the panel casting apparatus to the other while selectively pouring concrete vertically into each concrete receiving insert via a plurality of dispenser valves. Chains and threaded compression rods are fastened across the panel casting apparatus to properly shape and set up the concrete. A surrounding platform with towers couplable to a fall restraint system enables users to safely supervise the casting process. Upon curing, the concrete wall panels are removed by crane and transported to a nearby building for final installation.

### CROSS-REFERENCE TO RELATED APPLICATIONS

This application claims the benefit of U.S. Provisional Application Ser. No. 63/382,230, filed on Nov. 3, 2022, which is incorporated herein by reference.

### TECHNICAL FIELD

The present disclosure relates to precast concrete wall panels. More particularly, the present disclosure relates to systems and methods for transporting, assembling, and installing precast concrete wall panels at scale.

### BACKGROUND

Precast concrete walls are traditionally constructed by casting concrete in a reusable wall mold or form which is then cured in a controlled environment, transported to the installation site, and lifted into place. Precast concrete walls provide a single cladding assembly that enables quick, straightforward exterior finish wall applications for a building. The conventional construction of concrete panels, however, presents many safety risks and efficiency challenges. For example, the logistical difficulty alone to transport heavy concrete wall panels long distances, a few at a time, using conventional large trailers and portable tower cranes can disrupt the building schedule and quickly exhaust a budget. The transportation process for concrete wall panels also requires meticulous handling and care at each loading and offloading step between the factory and the installation site.

Solid concrete wall panels may weigh in excess of 150 pounds per cubic foot, making them extremely heavy and costly to transport long distances. The installation process often proceeds slowly and at great expense as concrete wall panels are transported from the assembly factory to the installation site, removed from trailers, and then hoisted and individually erected as part of the building façade or structure. The timetable and scope of the precast concrete wall assembly directly affects other trades and the overall building schedule and budget.

Accordingly, there is a need for systems and methods that increase the overall efficiency of concrete wall panels in the construction process, thereby saving time and financial resources. The concrete panel assembly system and related method of use disclosed herein solve these problems and others.

### SUMMARY OF EXAMPLE EMBODIMENTS

In some embodiments, a concrete panel assembly system comprises a panel casting apparatus having two outer forms that surround a plurality of dividers and concrete receiving inserts. Each of the concrete receiving inserts comprises two side panels (i.e., bulkheads) coupled to rebar mesh, the rebar mesh forming the body of the concrete receiving insert, hanger plates, spreaders, spring-loaded ties, and a foam board. The concrete receiving inserts are custom assembled with spacings for windows, doors, steel embeds, and electrical fixtures at an offsite factory and transported to the installation site without the weight of the concrete. The panel casting apparatus is transported via a panel trailer to the installation site, wherein the two outer forms constitute the spine of the panel trailer, thereby reducing the overall weight of the panel trailer. The dividers are transported to the installation site via a divider trailer.

In some embodiments, the panel casting apparatus further comprises a concrete hopper for vertically funneling concrete between the dividers into the concrete receiving inserts. The concrete hopper may comprise a bucket, a hopper valve, a wall dispenser, a plurality of dispensers, and a plurality of dispenser valves, whereby the user may simultaneously dispense the concrete in controlled quantities proportional to each individual concrete receiving insert. The panel casting apparatus comprises a conveyor coupled to the concrete hopper configured to move the hopper from one side of the panel casting apparatus to the other along tracks on the two outer forms. The panel casting apparatus also comprises pairings of chain tensioner brackets mounted opposite one another along the two outer forms with chains coupled transversely therebetween across the panel receiving inserts. The chains exert inward pressure against the concrete receiving inserts along with threaded compression rods to properly shape and set up the concrete. The panel casting apparatus, in some embodiments, comprises a platform or catwalk that surrounds the concrete receiving inserts and towers coupled to a cable whereby the user can attach a fall restraint system for safety purposes.

In some embodiments, upon partial curing, the newly formed concrete wall panels are removed by crane using lifting mechanisms featuring chamfered edges with steel embed pick points made of steel or rebar incorporated into the concrete wall panels. The concrete wall panels are staged into curing racks to await transport to the installation site, the dividers and ends are washed, and the process begins anew. In accordance with the building schedule, the concrete wall panels are again lifted by crane and transported by trailer to a nearby building for final installation.

### BRIEF DESCRIPTION OF THE DRAWINGS

FIG. 1 illustrates a top, front perspective view of a panel casting apparatus;

FIG. 2 illustrates a top, rear perspective view of a panel casting apparatus;

FIG. 3 illustrates a front, side perspective view of a concrete receiving insert being assembled in a factory;

FIG. 4 illustrates a top, front perspective view of a concrete receiving insert;

FIG. 5 illustrates a top, front perspective view of a hanger plate and rebar mesh of a concrete receiving insert;

FIG. 6 illustrates a top, front perspective view of a concrete receiving insert with a foam board;

FIG. 7 illustrates a top, front perspective view of foam delamination ties coupled to a foam board within a concrete receiving insert;

FIG. 8 illustrates a top, front perspective view of spring-loaded ties coupled to rebar mesh of a panel frame;

FIG. 9 illustrates a top, front perspective view of a divider;

FIG. 10 illustrates a top, front, side perspective view of a divider trailer;

FIG. 11 illustrates a top, rear, side perspective view of a divider trailer;

FIG. 12 illustrates a top, front, right-side perspective view of a panel trailer;

FIG. 13 illustrates top, rear, left-side perspective view of a panel trailer;

FIG. 14 illustrates a detailed, side perspective view of transport stabilizer arms;

FIG. 15 illustrates top, front perspective view of a platform surrounding two outer forms coupled together by top tie down brackets;

FIG. 16 illustrates a top front perspective view of a panel casting apparatus with three concrete receiving inserts and four dividers between two outer forms, demonstrating the adjustability of the panel casting apparatus;

FIG. 17 illustrates a detailed, side perspective view of a panel casting apparatus with threaded compression rods extending outwards from pivotable base members;

FIG. 18 illustrates a top, front perspective view of a plurality of concrete receiving inserts separated by dividers and compressed together by pairings of chain tensioner brackets and chains;

FIG. 19 illustrates a top, rear perspective view of a concrete hopper on a panel casting apparatus;

FIG. 20 illustrates a front, side perspective view of a plurality of dispenser valves with the bucket of the concrete hopper removed for clarity;

FIG. 21 illustrates a top, side perspective view of a conveyor and tracks;

FIG. 22 illustrates a top, side perspective view of wheels and tracks with the chassis and motor of the conveyor removed for clarity;

FIG. 23 illustrates a top, front perspective view of a concrete wall panel;

FIG. 24 illustrates a top, side perspective view of a panel casting apparatus, a crane, concrete trucks, and curing racks loaded with concrete wall panels on the jobsite.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a precast concrete wall panel system that performs more of the casting process onsite with enhanced means of transportation to optimize the building schedule, thereby completing the project scope earlier than traditional methods and at less cost. By pouring the concrete onsite as opposed to offsite, significant handling and transportation challenges are resolved. The present disclosure addresses these opportunities and others.

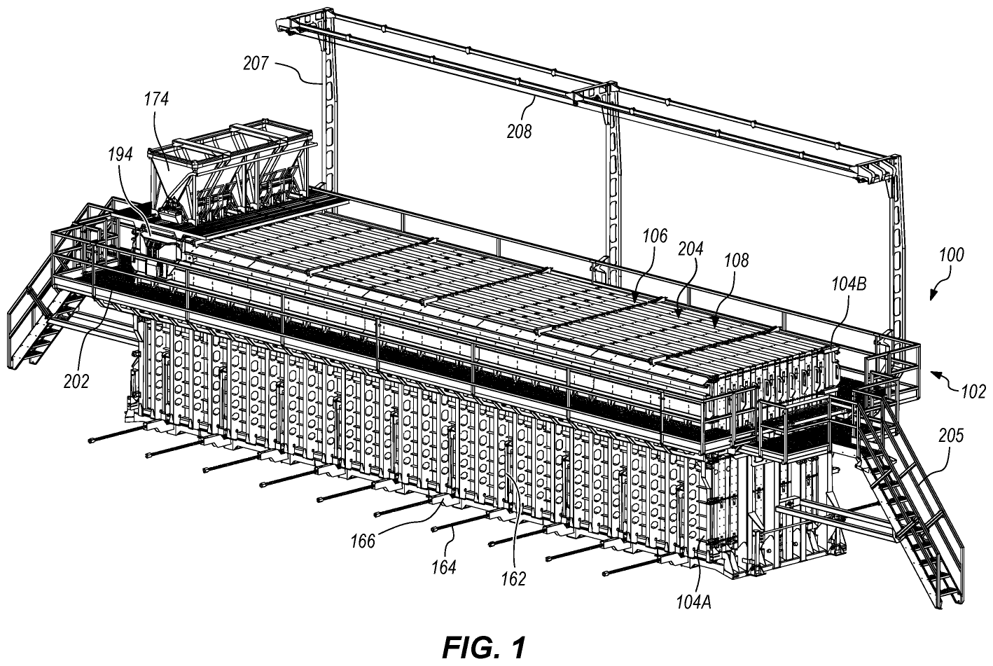

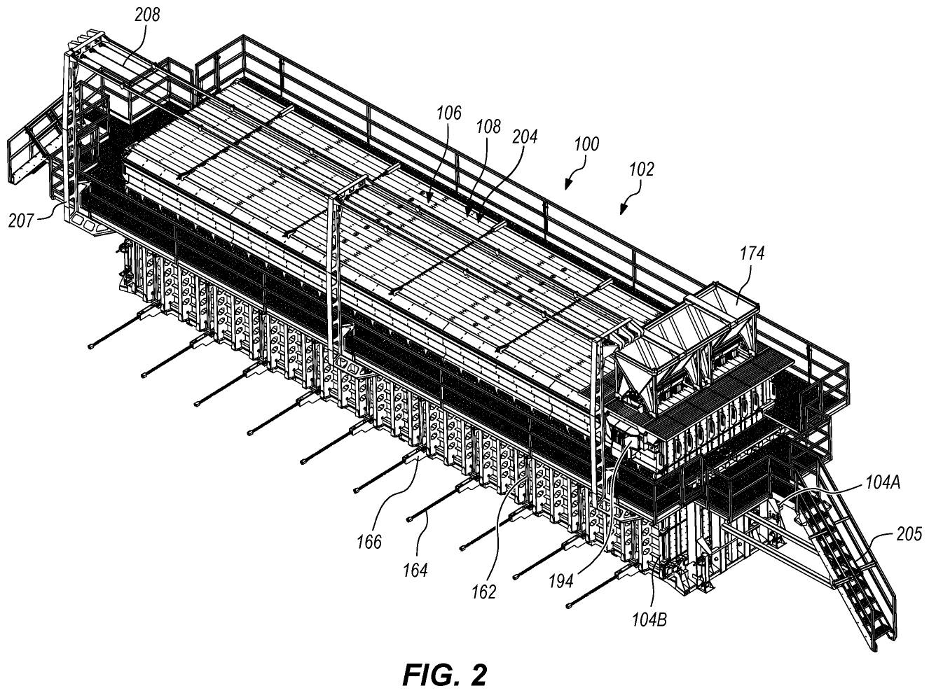

As illustrated in FIGS. 1-2, a panel casting system 100 comprises a panel casting apparatus 102 having two outer forms 104A-B that surround a plurality of dividers 106 and a plurality of concrete receiving inserts 108. An interior width between the two outer forms 104A-B may be adjusted (i.e., narrowed or widened) to accommodate varying widths and quantities of both the dividers 106 and the concrete receiving inserts 108 housed therebetween, according to the needs of the building project for which the final concrete wall panels 204 are being cast. In some embodiments, the panel casting apparatus 102 may comprise nine concrete receiving inserts 108 partitioned between eleven total dividers 106; however, more or fewer dividers 106 and concrete receiving inserts 108 may be used without departing from the teachings herein. A divider 106 adjoins both the left and right side of each concrete receiving insert 108 to provide an interim structural housing or mold wherein concrete may be poured over the concrete receiving inserts 108 and allowed to cure. As shown in FIGS. 1-2, the concrete receiving inserts 108 have already been covered in concrete and are undergoing the curing phase to become concrete wall panels 204.

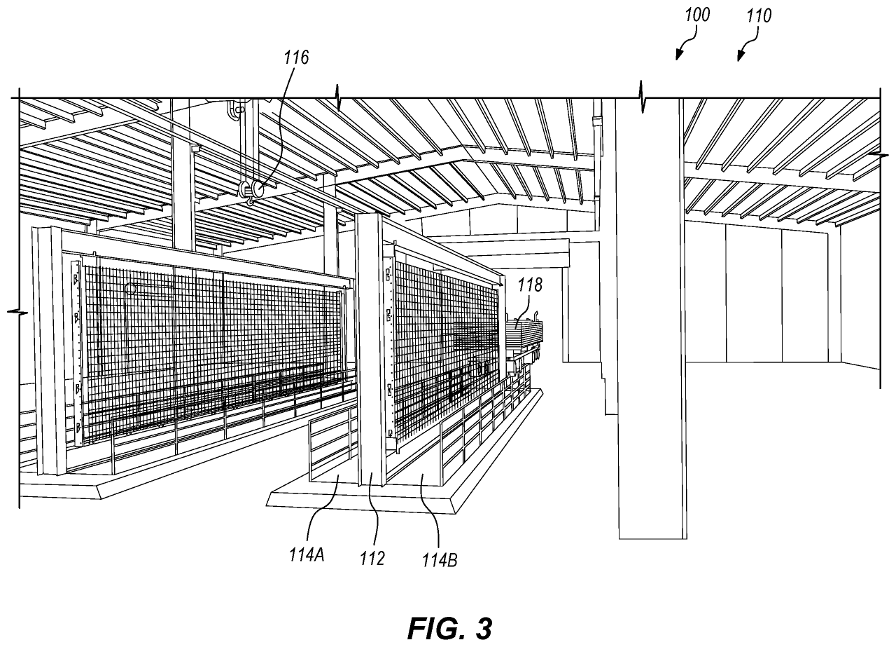

FIG. 3 illustrates an offsite factory 110 wherein concrete receiving inserts 108 are custom fabricated. Each concrete receiving insert 108 may be assembled by technicians to discrete specifications at a workstation, in some embodiments, featuring a mounting rack 112 with platforms 114A-B on either side thereof. The mounting rack 112 may be a rectangular framework of I-beams or other structure that receives the steel members of the concrete receiving insert 108 during assembly. To assist the technicians in the assembly process, the mounting rack 112 may be hydraulically or otherwise mechanically configured to move upwards and downwards relative to the platforms 114A-B. This movement enables the technicians to take advantage of a vertical panel assembly rather than a horizontal panel assembly resulting in potential ergonomic efficiencies. Assembly conducted from a standing position, for example, prevents overexertion and hyperextension of the technicians' back muscles caused by repeatedly bending over a horizontal panel assembly as currently practiced in the art. In some embodiments, the platforms 114A-B surrounding the mounting rack 112 may alternatively or additionally be raised and lowered to similar effect. Once completed, a gantry crane 116 may lift the concrete receiving insert 108 from the mounting rack onto a trailer 118 for transportation to the installation site.

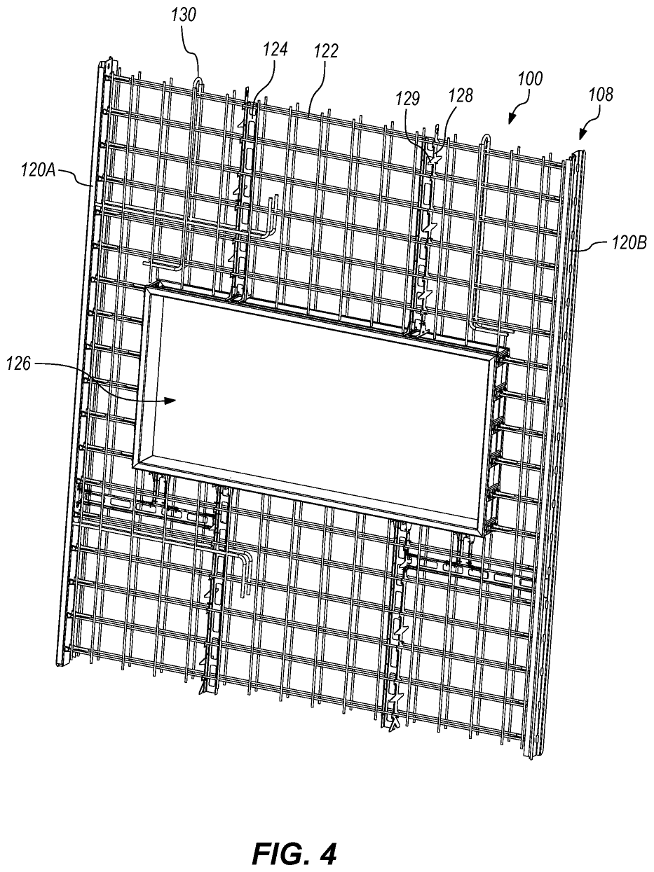

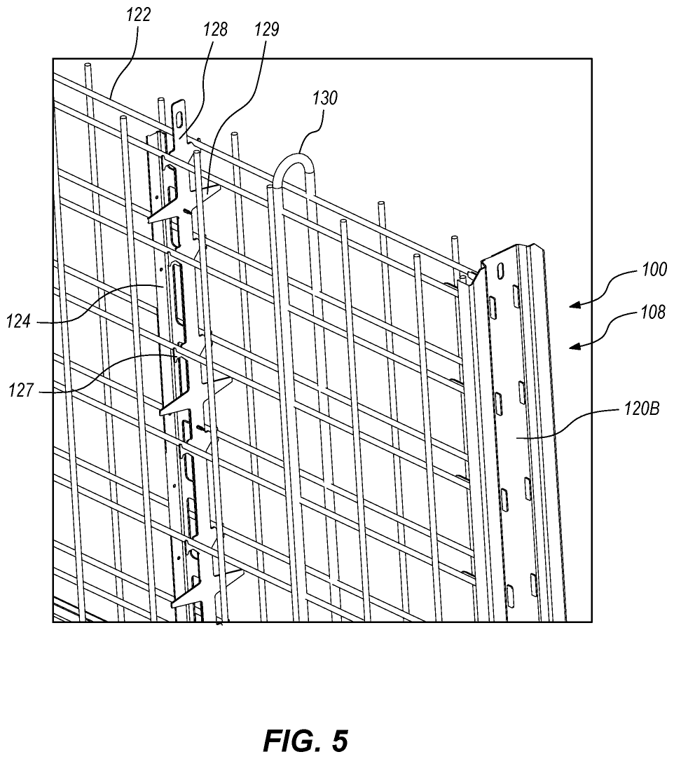

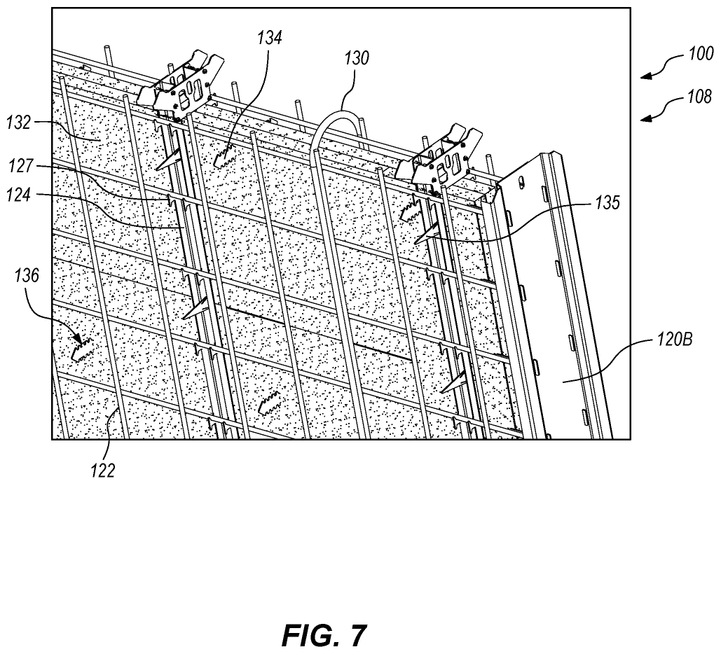

FIGS. 4-8 illustrate varying perspective views of an exemplary embodiment of the concrete receiving insert 108. As shown in FIG. 4, the concrete receiving insert 108 comprises two side panels 120A-B (i.e., bulkheads) coupled to rebar mesh 122, the rebar mesh 122 forming the body of the concrete receiving insert 108. As best seen in FIG. 5, the concrete receiving insert 108 may comprise one or more hanger plates 124 to provide supporting structure for the addition of openings 126 (FIG. 4) such as doors, windows, and electrical fixtures in the finalized concrete wall panel. The hanger plates 124 may be coupled by clips, brackets, etc. between a frame of the openings 126 and extend along the body of the concrete receiving insert 108 to the ends thereof. The hanger plates 124 comprise spreaders 128 and are couplable to the rebar mesh 122 via clasped members (e.g., hooks 127). The spreaders 128, in some embodiments, may be steel wedges 129 that extend bidirectionally along a transverse axis of the concrete receiving insert 108 and function to maintain adjacent dividers 106 equidistant from one another in the panel casting apparatus 102. The length of the spreaders 128 determines the final width of each concrete wall panel. It will be appreciated that the spreaders 128 also maintain all of the elements of the concrete receiving inserts 108 together without the need for through ties or other penetrations as traditionally used in the precast concrete panel industry.

The concrete receiving insert 108 may further comprise lift points 130 along the top, bottom, and/or sides thereof which feature loops or brackets that project beyond the dimensions of the concrete receiving insert 108 that will later be covered in concrete, as well as projections that extend from the loops of the lift points 130 into the body of the concrete receiving insert 108, acting as anchors. The lift points 130 provide a convenient means for a user to move the concrete receiving inserts 108 both before and after receiving concrete. The concrete receiving insert 108 may comprise steel embed plates or other anchors that are later cast with the concrete to accommodate coupling with structural components such as joists, girders, etc. The steel embed plates may feature lugs or studs welded thereto that bind the concrete to the steel structural components. The steel embed plates, in some embodiments, may be galvanized to prevent rusting and other corrosion.

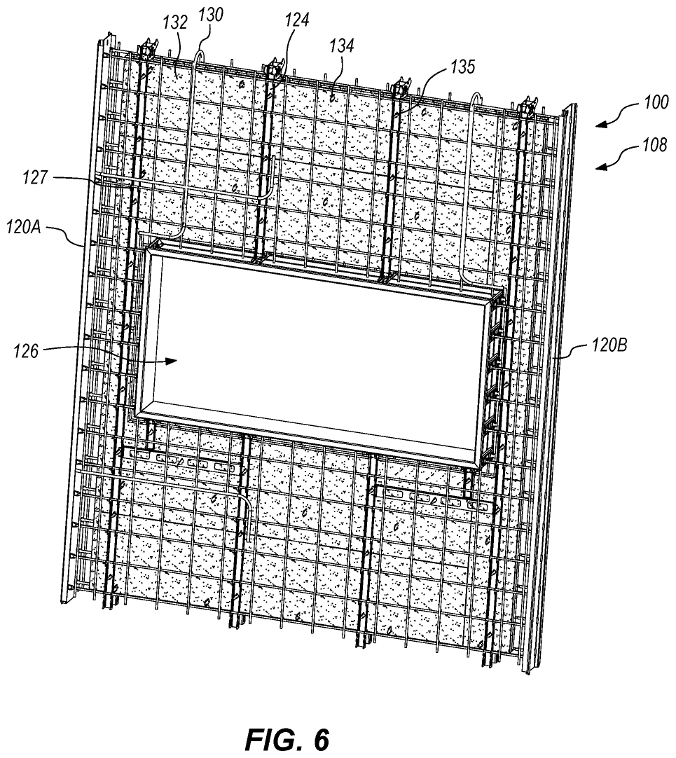

Referring to FIGS. 6-8, the concrete receiving insert 108 may comprise a foam board 132. The foam board 132 may be layered substantially across the body of the concrete receiving insert 108 between the rebar mesh 122. The foam board 132 acts as insulation to improve steady state thermal performance (i.e., R-values) and improve air and moisture infiltration properties. The foam board 132, in some embodiments, may comprise expanded polystyrene, extruded polystyrene, polyisocyanurate, and related materials, as well as open-cell and closed-cell spray-applied or foamed-in-place insulations. Foam delamination ties 134 and sandwich plates 135 may be inserted into the foam board 132 at periodic intervals to maintain the foam board 132 flush and centered between the two side panels 120A-B and rebar mesh 122. The foam delamination ties 134 may include a series of metal teeth 136 in a sawtooth pattern along the sides that facilitate gripping of the foam board 132 and provide surface area along which the concrete can settle and cure. It will be appreciated that a unique aspect of all the embodiments of the panel casting system 100 is that the concrete may be poured vertically from the top of the concrete receiving inserts 108 downwards in a single step process with a limited footprint. In contrast, industry practice typically pours concrete over the forms while the wall panels are lying horizontal across the ground. When concrete is poured with the wall panels in a horizontal orientation, there is more surface area to manually cover than when the wall panels are in a vertical orientation. The panel casting system 100 thus conserves time and effort when pouring concrete.

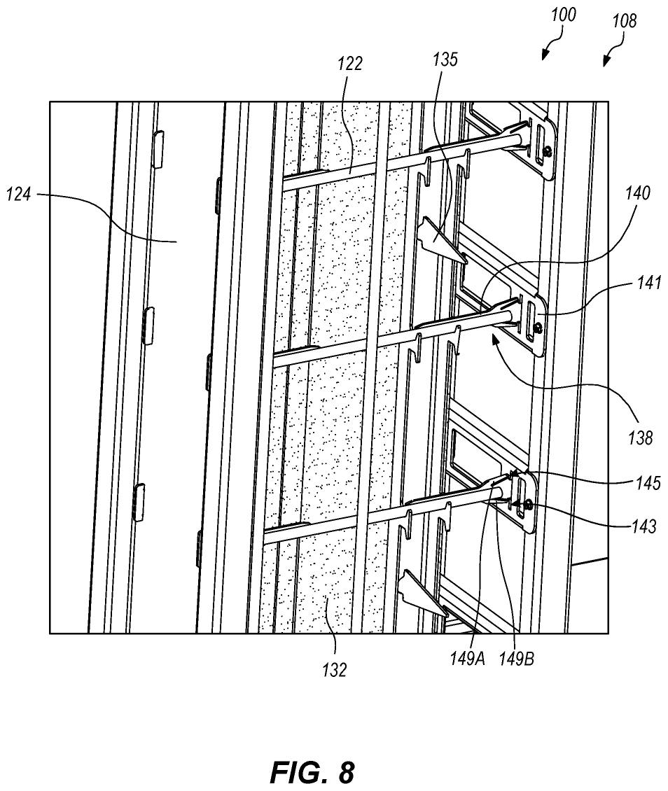

As shown in FIG. 8, the concrete receiving inserts 108 may comprise tie connections 138 between the rebar mesh 122 and the frame. The tie connections 138 may comprise spring-loaded ties 140 or clips that are inserted into a tie bracket 141 or other coupling mechanism and welded or tied together with the rebar mesh 122. The tie bracket 141 may comprise a first slot 143 with a first length adjoined to a second slot 145 with a second length, the second length being smaller than the first length. Each of the tie connections 138 may feature a T-shaped head with a body that tapers in width and two prongs 149A-B on the side of the body. The T-shaped head of the tie connection may be inserted into the second slot 145 of the tie bracket 138 and then forcibly coupled and secured into the second slot 145, in some embodiments, by the force of the spring-loaded ties 140 when actuated. In other words, the two prongs 149A-B on the side of the body are forced (spring) inward as the spring-loaded nail 140 is forced through the second slot 145. Once sufficiently through the second slot 145, the two prongs 149A-B spring back open, thereby preventing withdrawal of the spring-loaded nail 140 through the second slot 145.

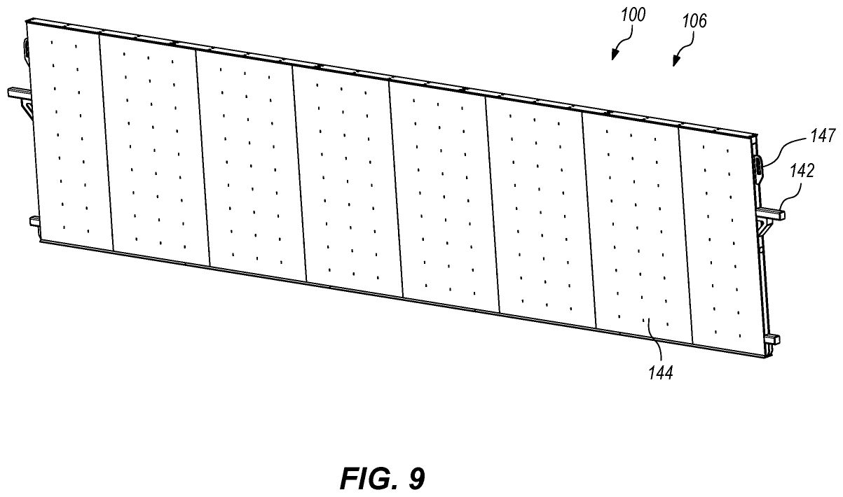

FIG. 9 illustrates a perspective view of a representative divider 106. The divider 106 comprises a panel which in some embodiments has a substantially rectangular shape, though other shapes may also be used. The divider 106 may comprise bars 142 that extend along the longitudinal axis of the divider 106 used to mount the divider 106 within the panel casting apparatus 102. The divider 106 may also comprise lifting points for rigging 147 on each side to enable the user to use lifting machinery to make necessary adjustments to its positioning. In some embodiments, though without limitation, the dividers 106 are 50 feet in length, enabling the casting of corresponding concrete wall panels 108 that are up to 50 feet in length. However, it will be appreciated that other lengths and dimensions may be used without departing herefrom. In some embodiments, the divider 106 may comprise a mold 144 that is couplable to each of the finished concrete wall panels during the casting and/or curing phases. The mold 144 may be made of silicone or other forming compatible material that can shape the cast of the final concrete wall panel with a faux finish (e.g., bricks, rocks, or other decorative architectural texture).

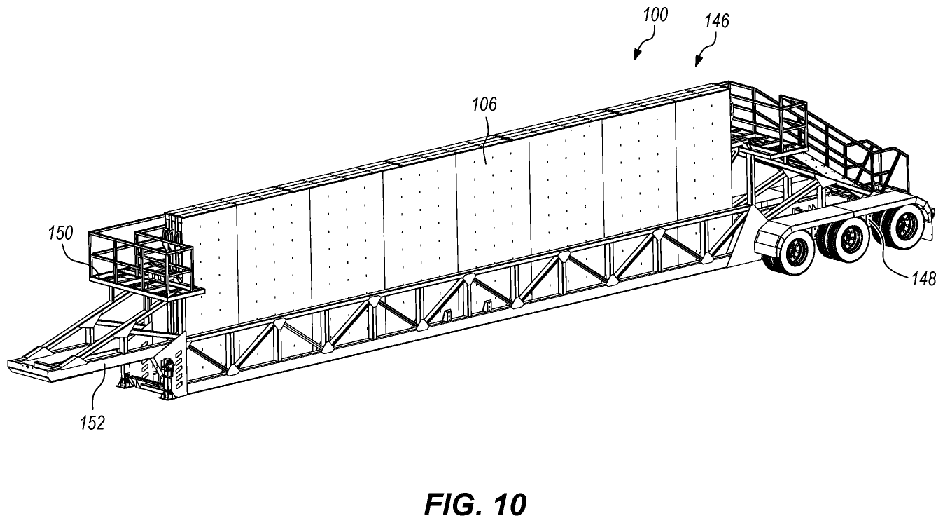

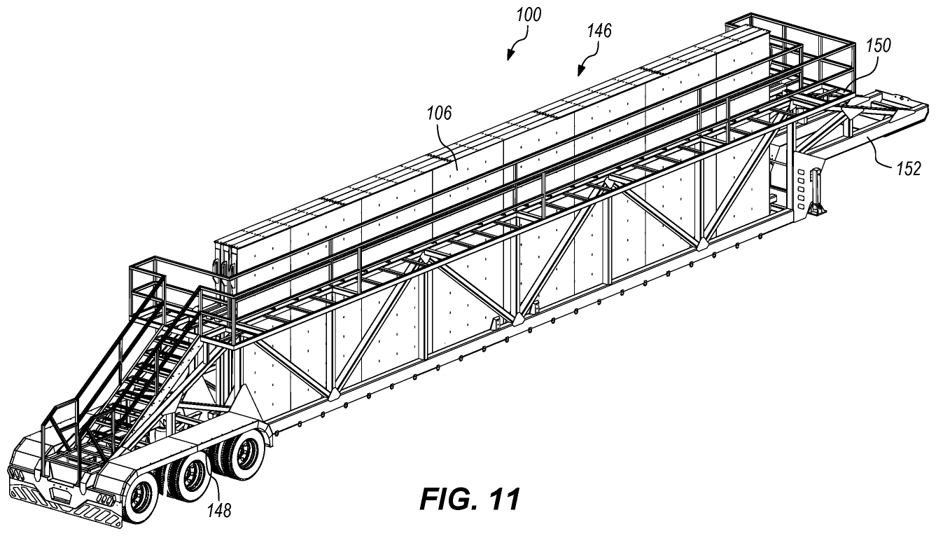

FIGS. 10-11 illustrate a divider trailer 146 configured to transport the plurality of dividers 106 to and from an onsite location where the concrete wall panels are cast. Due to the extreme weight and size of the dividers 106 and/or concrete wall panels 108, the divider trailer 146 may comprise a suspension system 148 and axles to accommodate an oversize and overweight load. The divider trailer 146 may comprise stairs and an elevated platform 150 or catwalk that enables the user to view and maneuver the dividers 106 and/or concrete wall panels into position on the divider trailer 146. The bars 142 on the dividers 106 are couplable to the divider trailer 146 for secure transportation of the load. A fifth wheel attachment 152 or other hitch mechanism may be used to secure the divider trailer 146 to a semitruck via quick connect, locking nut system, etc.

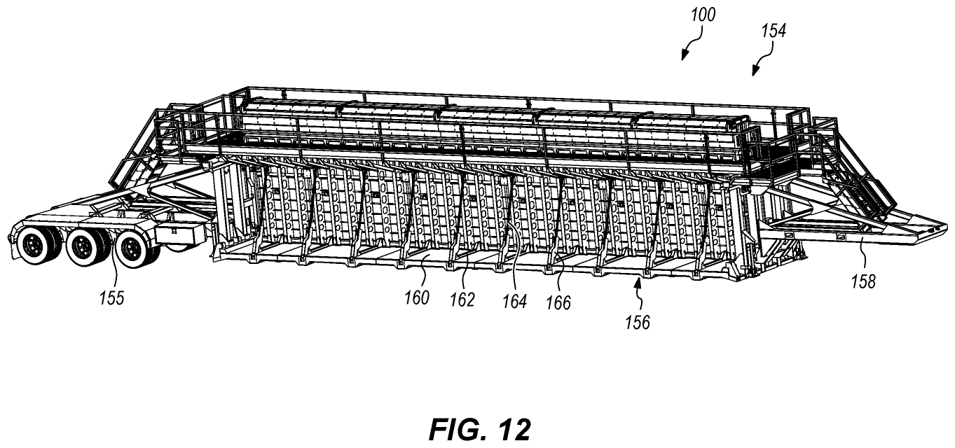

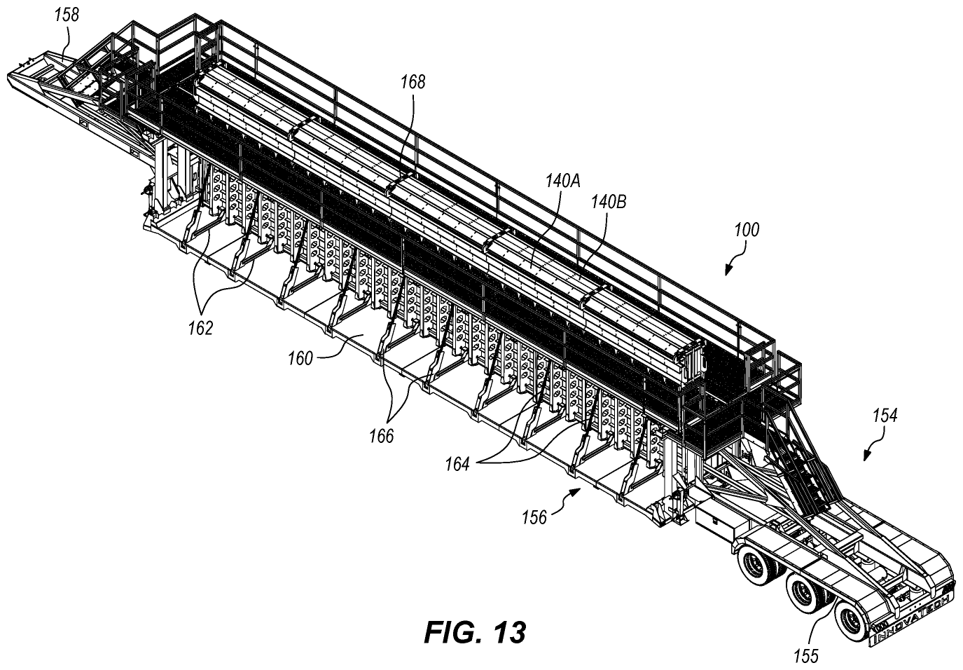

FIGS. 12-13 illustrate a panel trailer 154 carrying the panel casting apparatus 102 in a transportation configuration 156. The panel trailer 154 is configured to transport the panel casting apparatus 102 to and from the onsite location where the concrete wall panels are cast. Similar to the divider trailer 146, the panel trailer 154 may comprise a suspension system 155 and axles to accommodate an oversize and overweight load. Likewise, a fifth wheel attachment 158 or other hitch mechanism may be used to secure the panel trailer 154 to a semitruck. The panel casting apparatus 102 comprises a steel floor 160 with transport stabilizer arms 162. The steel floor 160 doubles as the foundation of the panel casting apparatus 102 during use and the body of the panel trailer 154 during transportation. The two outer forms 104A-B constitute the structural spine of the panel trailer 154, minimizing the overall weight of the frame of the panel trailer 154. It will be appreciated that the cross-purpose use of structural elements of the panel casting system 100 both during use for casting and transportation, enables more efficient transportation from the offsite factory 110 and elsewhere to the onsite location where installation occurs and back.

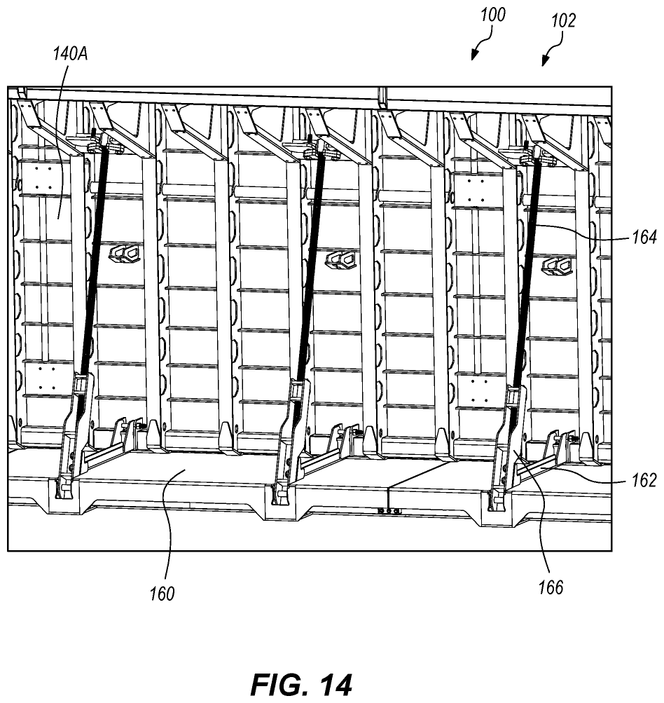

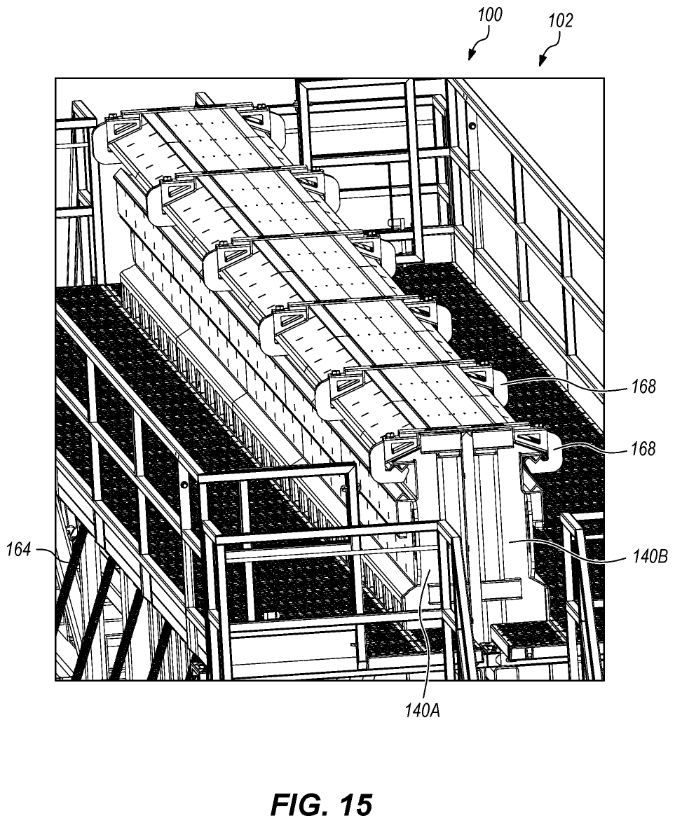

Referring to FIGS. 14-15, the transportation configuration 156 of the panel casting apparatus 102 while on the panel trailer 154 comprises threaded compression rods 164 that extend from pivotable base members 166 along the steel floor 160. In preparation for transportation, the pivotable base members 166 rotate upwards towards the sides of the two outer forms 104A-B. The threaded compression rods 164 are then fastened to the two outer forms 104A-B at an angle (e.g., 45-degree angles). The transportation configuration 156 of the panel casting apparatus 102 may also comprise transport stabilizer arms 162 that are couplable between the pivotable base members 166 and the outer forms 104A-B. The transport stabilizer arms 162 ground and support the threaded compression rods 164 to reduce the strain on them resulting from reinforcing the two outer forms 104A-B. Several threaded compression rods 164 may be couplable on each side of the panel casting apparatus 102 to center the weight of the two outer forms 104A-B along the panel trailer 154 during transportation. It will be appreciated that the two outer forms 104A-B create the structural spine of the panel trailer 154, minimizing the overall weight of the frame of the panel trailer 154. The transportation configuration 156 of the panel casting apparatus 102 may further comprise top tie down brackets 168 that safely secure the two outer forms 104A-B together during transportation on the panel trailer 154. The top tie down brackets 168 may comprise a clamp or other fastening mechanism that is coupled to tracks along the sides of the two outer forms 104A-B. The top tie down brackets 168 may comprise a bar that extends between opposite pairings of clamps on each of the two outer forms 104A-B and is bolted to the clamps. In this manner, the top tie down brackets 168 securely lock the two outer forms 104A-B together to prevent movement during transportation. While not shown, one or more of the concrete receiving inserts 108 may be positioned between the two outer forms 104A-B during transportation or transported separately on the trailer 118 (FIG. 3).

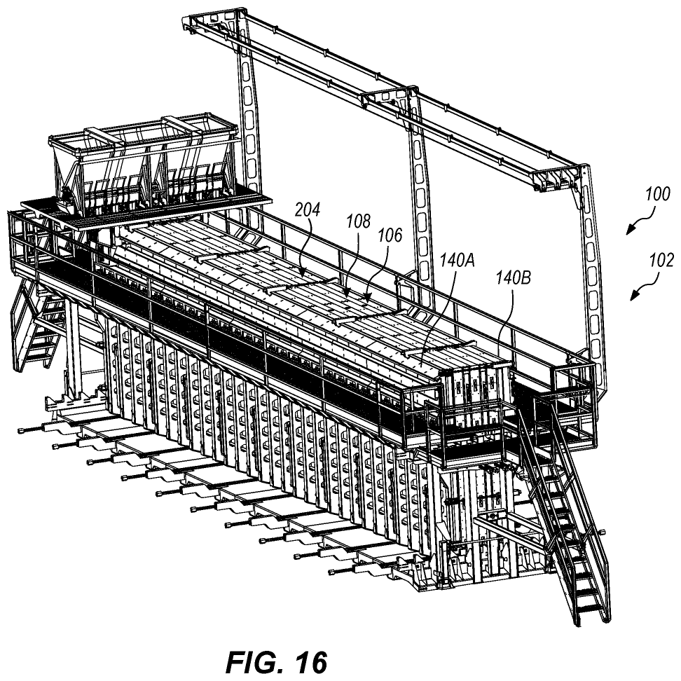

FIG. 16 is a top perspective view of the panel casting apparatus 102 in a configuration having three concrete receiving inserts 108. As discussed earlier, the panel casting apparatus 102 is capable of several configurations, receiving, without limitation, between one to nine concrete receiving inserts 108. In each configuration, every concrete receiving insert 108 is surrounded by a divider 106 on either side. As shown, for example, a configuration with three concrete receiving inserts 108 has four dividers 106, all of the above bookended by the two outer forms 104A-B. To accommodate additional concrete receiving inserts 108 and dividers 106, a user moves the two outer forms 104A-B farther apart from one another by sliding or lifting them across the steel floor 160. It is contemplated that the steel floor 160, in some embodiments, may comprise tracks or channels configured to engage a jig system whereby the position of the two outer forms 104A-B may be easily adjusted with a gantry along the tracks and locked into position.

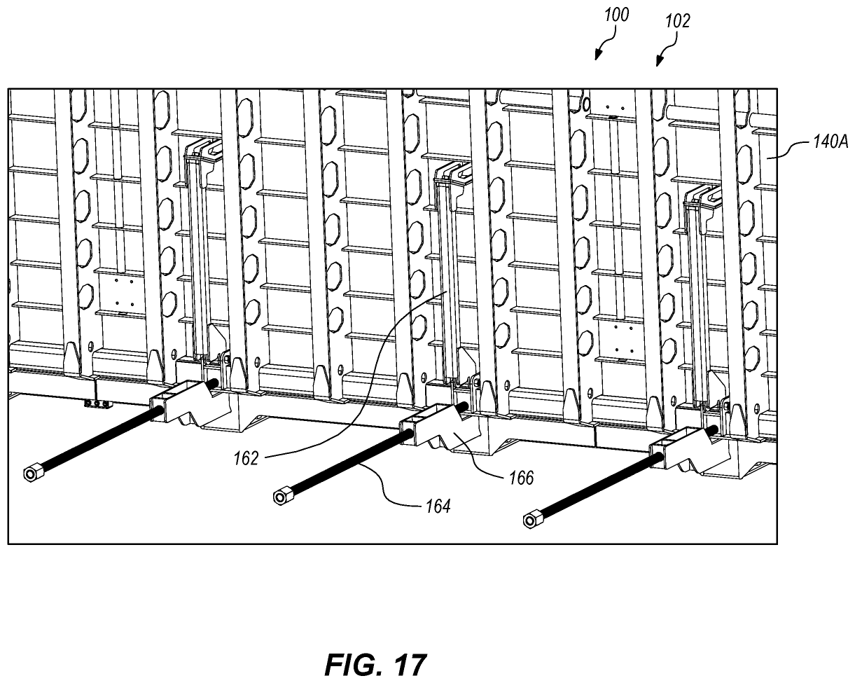

FIG. 17 is a close-up, side perspective view of the panel casting apparatus 102. Upon transportation to the jobsite, the panel casting apparatus 102 may be decoupled and unloaded from the panel trailer 154. The threaded compression rods 164 may then be decoupled from the two outer forms 104A-B and extended outwardly towards the ground. The user may, at the same time, rotate the pivotable base members 166 until the threaded compression rods 164 are perpendicular to the two outer forms 104A-B and substantially parallel with the ground. In this manner, the transport stabilizer arms 162 that previously supported the pivotable base members 166 may be decoupled therefrom and rotated upwards from the steel floor 160 and secured along the sides of the two outer forms 104A-B. Later, during the pouring stage of the concrete, the threaded compression rods 164 may be fastened (e.g., threaded) against the two outer forms 104A-B, pressing them inward towards one another. This additional pressure against the two outer forms 104A-B helps to keep the concrete receiving inserts 108 and dividers 106 properly aligned with one another to prevent unwanted movement during the concrete pouring and curing processes.

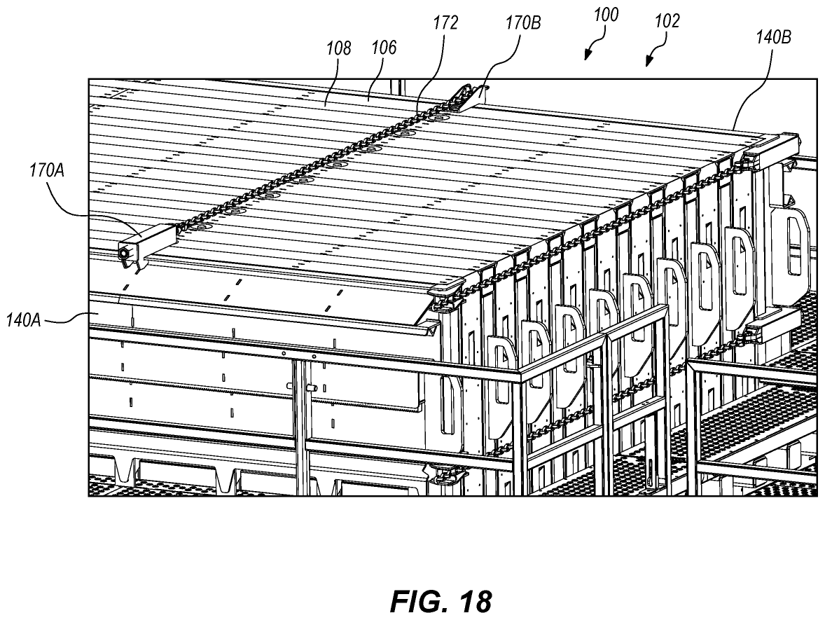

As illustrated in FIG. 18, in some embodiments, the panel casting system 100 may comprise pairings of chain tensioner brackets 170A-B mounted opposite one another along the two outer forms 104A-B or other frame members. Each pairing of chain tensioner brackets 170A-B may be shackled or otherwise coupled to a chain 172 that is positioned transversely across the outer surfaces of the concrete receiving inserts 108 and dividers 106 between each pairing of chain tensioner brackets 170A-B. The chain tensioner brackets 170A-B may be mounted on both the top and the sides of the two outer forms 104A-B to provide pressure against the concrete receiving inserts 108, while the threaded compression rods 164, as shown and discussed earlier, provide pressure along the bottom. During the curing process, a user may gradually tighten the chain tensioner brackets 170A-B to correspondingly contract a length of each chain 172 across the concrete receiving inserts 108 and dividers 106. The additional force exerted by the chain tensioner brackets 170A-B inwardly against the concrete panels causes any wet concrete to further fill in the spacing within each concrete receiving insert 108 and sets up the finalized concrete wall panel. The chain tensioner brackets 170A-B may be periodically tightened until the concrete wall panels are fully cured. In some embodiments, though without limitation, each chain 172 may be a 7100 lb. 0.375 grade-80 lifting chain, commensurate to the weight of the concrete wall panels.

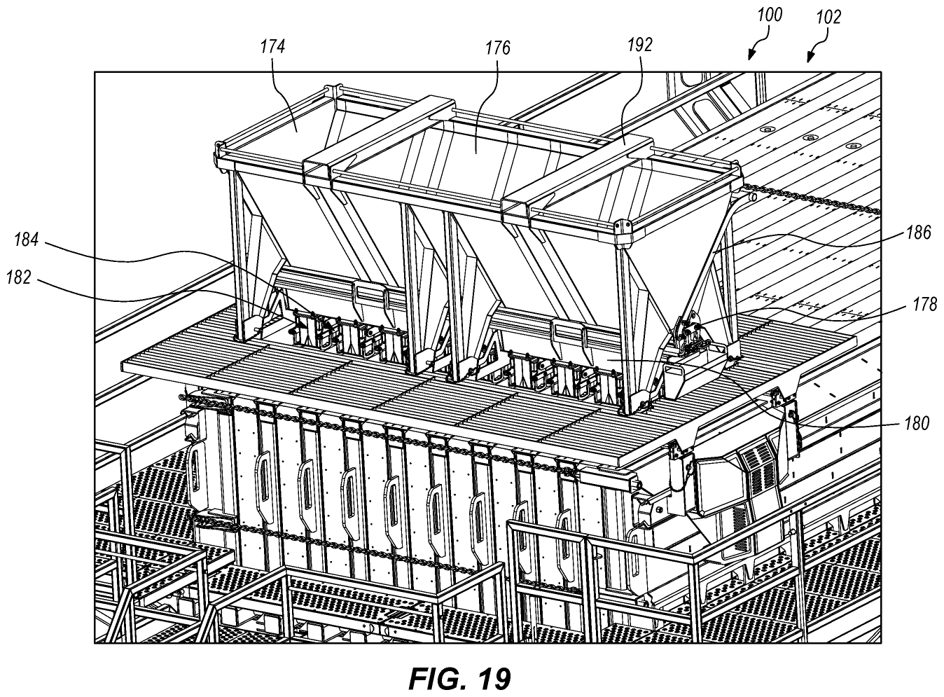

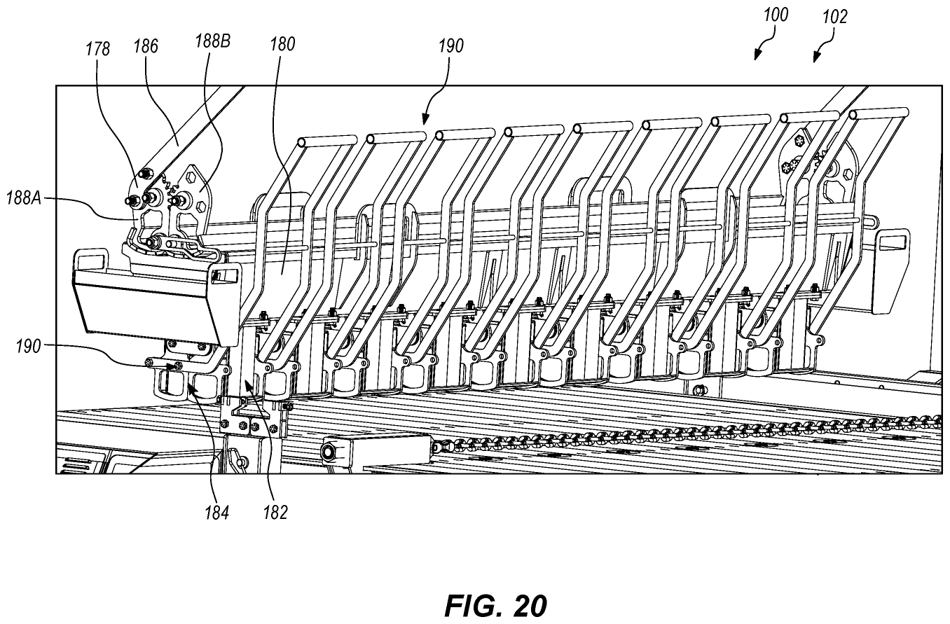

Referring to FIGS. 19-22, the panel casting apparatus 102 may comprise a concrete hopper 174 configured to pour concrete between the dividers 106 into the concrete receiving inserts 108. The concrete hopper 174 comprises a bucket 176, a hopper valve 178, a wall dispenser 180, a plurality of dispensers 182, and a plurality of dispenser valves 184. The bucket 176 is a trough or other receptacle with a large opening at the top and a body for receiving concrete that gradually tapers downwards like a funnel to channel the concrete towards the wall dispenser 180. The hopper valve 178, in some embodiments, comprises a handle 186 coupled to a first half 188A of a closure mechanism, a second half 188B of the closure mechanism coupled by interlocking gears to the first half 188A. Both the first half 188A and the second half 188B of the closure mechanism comprise sheets of metal that extend across the opening of the wall dispenser 180 to seal off the opening while the hopper valve 178 is closed. When the handle 186 of the hopper valve 178 is actuated by the user, the first half 188A and the second half 188B of the closure mechanism spread apart to expose the opening of the wall dispenser 180 and permit concrete to flow thereinto. The panel casting system 100 pours concrete vertically from the top to the bottom of the concrete receiving inserts 108 while standard industry practice, by contrast, fills precast concrete forms horizontally from the sides. It will be appreciated that pouring the concrete onsite and/or nearby, rather than at a factory, dramatically saves on transportation costs associated with moving the heavy concrete wall panels long distances. Furthermore, finishing a concrete wall panel at a factory requires trowel finishing, whereas the dividers 106 by contrast inherently leave a finished surface on the concrete wall panels without a second finishing step.

Each dispenser of the plurality of dispensers 182 is coupled to the wall dispenser 180, a long trough that extends transversely across the tops of the dividers 106 and concrete receiving inserts 108. Each dispenser of the plurality of dispensers 182 is further aligned between the dividers 106 over the concrete receiving inserts 108. The plurality of dispensers 182 are coupled to the plurality of dispenser valves 184 with corresponding handles 190 capable of actuation by the user individually to pour concrete therethrough. The user may selectively open and close each valve 184 of the plurality of dispenser valves 184 according to the requirements of each concrete wall panel. For example, the user may reduce the flow rate for an individual dispenser of the plurality of dispensers 182 when positioned over the openings 126 such as a door or window of a concrete receiving insert 108 allowing each individual cell (i.e., the space around each concrete receiving insert 108 and between two adjacent dividers 106) to be filled equally to eliminate any pressure differential across the two outer forms 104A-B of the panel casting apparatus 102. Moreover, the layout of the plurality of dispensers 182 and the dimensions of the concrete hopper 174 may be varied and exchanged to accommodate walls of varying thickness. In some embodiments, two or more dispensers of the plurality of dispensers 182 may pour concrete into a single cell to fill in thicker walls as compared to narrower walls that may be filled by a single dispenser.

In reference to the hopper valve 178 and the plurality of dispenser valves 184, it will be appreciated that other valve types may be used herein including butterfly valves, gate valves, ball valves, globe valves, plug valves, or any other flow control device that enables the user to regulate the flow of concrete through the wall dispenser 180 and the plurality of dispensers 182. The concrete hopper 174 may comprise overflow receptacles beneath the ends of the wall dispenser 180 to catch any excess concrete that overflows when the hopper valve 178 is opened and closed. The concrete hopper 174 may further comprise fork pockets 192 (FIG. 19) to enable a telescopic handler to transition the concrete hopper 174 on and off the panel casting apparatus 102 as needed for transportation, cleaning, etc.

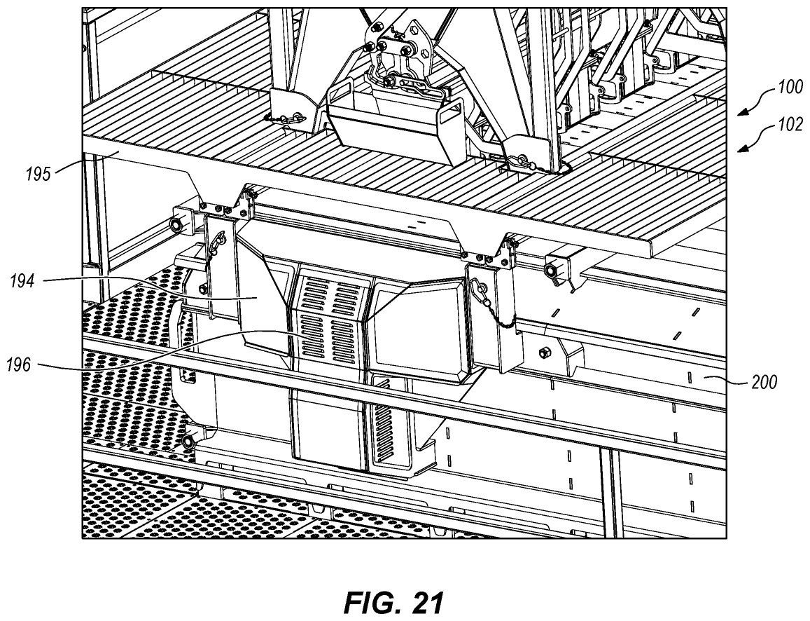

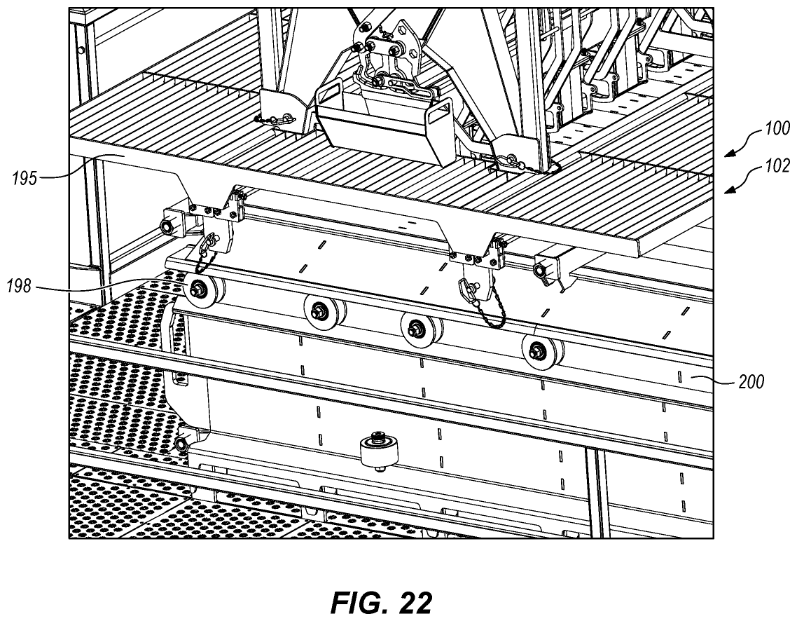

Referring to FIGS. 21-22, the panel casting apparatus 102 may comprise a conveyor 194 configured to move the concrete hopper 174 from one side of the panel casting apparatus 102 to the other. The conveyor 194 comprises a motor 196 that propels wheels 198 along tracks 200 to thereby drive the concrete hopper 174. The wheels 198 may predominantly be oriented perpendicular to the ground but may also be parallel to the ground and run along the surface of the two outer forms 104A-B to promote fluidity of movement. The conveyor 194 may be coupled directly to the concrete hopper 174 or indirectly to a platform 195 or frame around the concrete hopper 174. In either coupling configuration, the conveyor 194 positions the concrete hopper 174 above the two outer forms 104A-B, the dividers 106, and the concrete receiving inserts 108 such that the plurality of dispenser valves 184 are continuously aligned straight over the concrete receiving inserts 108. In some embodiments, the tracks 200 extend longitudinally along the two outer forms 104A-B. The user may manually engage the conveyor 194 by control panel or the timing and speed of the conveyor 194 may be preprogrammed for optimal concrete pouring results ahead of time. Other means of conveyance may be used to move the concrete hopper 174 without departing from the teachings herein.

Referring again to FIGS. 1-2, the panel casting apparatus 102, in some embodiments, comprises a platform 202 or catwalk on an upper level accessed by a staircase 205. The platform 202 may substantially circumscribe the panel casting apparatus 102 providing 360-degree access to the work area. The platform 202 enables the user to assist in the placement and removal of the concrete receiving inserts 108 and dividers 106, operate the concrete hopper 174, including the plurality of dispenser valves 184, better observe the setting concrete, make couplings with trailer attachments, and perform maintenance repairs as necessary. The panel casting apparatus 102 also comprises one or more towers 208 positioned above the platform 202 having a cable strung across them couplable to a fall restraint system 208 including a body belt or harness and a lifeline such that the user may freely move about the platform 202 while protected from falling hazards.

While not required, the panel casting apparatus 102 may comprise one or more vibratory motors (not shown) configured to distribute the concrete evenly throughout the concrete receiving inserts 108 and remove air bubbles and other imperfections from the concrete, wherein one or more electrical conduits may supply power to the one or more vibratory motor. The one or more vibratory motors may be positioned in housings aligned in rows and columns within the plurality of dividers 106 to disperse the vibratory force more evenly across the concrete as it sets within the concrete receiving inserts 108.

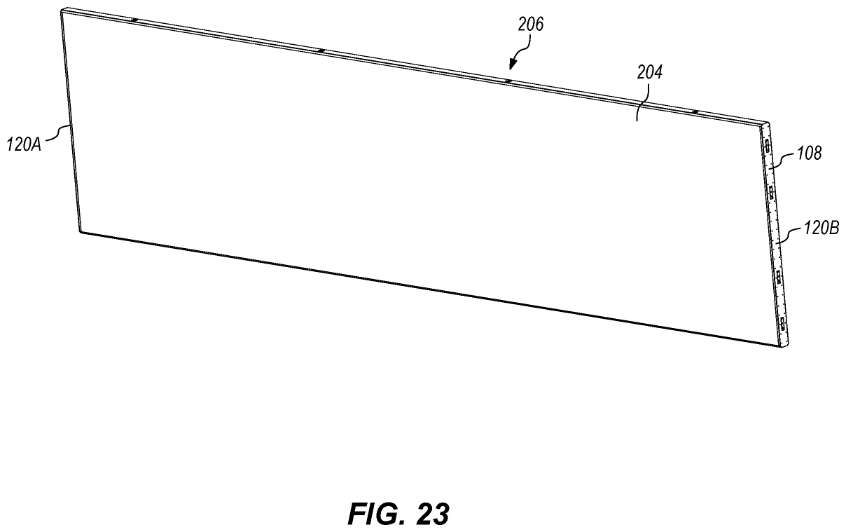

FIG. 23 illustrates a concrete wall panel 204 upon final curing. The concrete wall panel 204 comprises the concrete receiving insert 108 within it as covered in concrete. The two side panels 120A-B of the concrete receiving insert 108 are still visible along the sides of the concrete wall panel 204. The two side panels 120A-B feature handles and brackets for moving the concrete wall panels 204. The top of the concrete wall panel 204 also comprises a lifting mechanism 206 for coupling the concrete wall panel to a crane. The lifting mechanism 206 may be a chamfered edge with a stud or other anchor such as a tongue and groove coupling mechanism whereby a crane can be coupled to the concrete wall panel 204 and lift it out of the panel casting apparatus 102. It will be appreciated that the lifting mechanism 206 avoids the necessity to weld a plate to the concrete wall panel 204 and caulk it down, as currently practiced in the prior art.

It will be appreciated that concrete wall panels 204 act as thermal storage to delay and reduce peak thermal loads. The concrete wall panels 204 may be used as an interior surface which saves time and money by eliminating the need for separate stud framing and drywall costs or may be used as load-bearing structures that save costs by eliminating the need for an additional structural framing system. Due to concrete's durability, the concrete wall panels 204 create a low maintenance structure, which also stands up to harsh climate conditions.

In some embodiments, the concrete wall panels 204 may comprise a thin brick veneer that can achieve a traditional appearing facade. The concrete wall panels 204 can alternatively be produced with textures including form liner shapes, artwork, and lettering to provide distinctive accent treatments. For example, colors and finishes can be achieved through the use of various aggregates, cement, pigments, and finishing techniques. The concrete wall panels 204 can also have electrical boxes, conduits, and other features cast into the concrete wall panels 204 to provide flush electrical fixtures on concrete wall panels 204 that are not to be framed out.

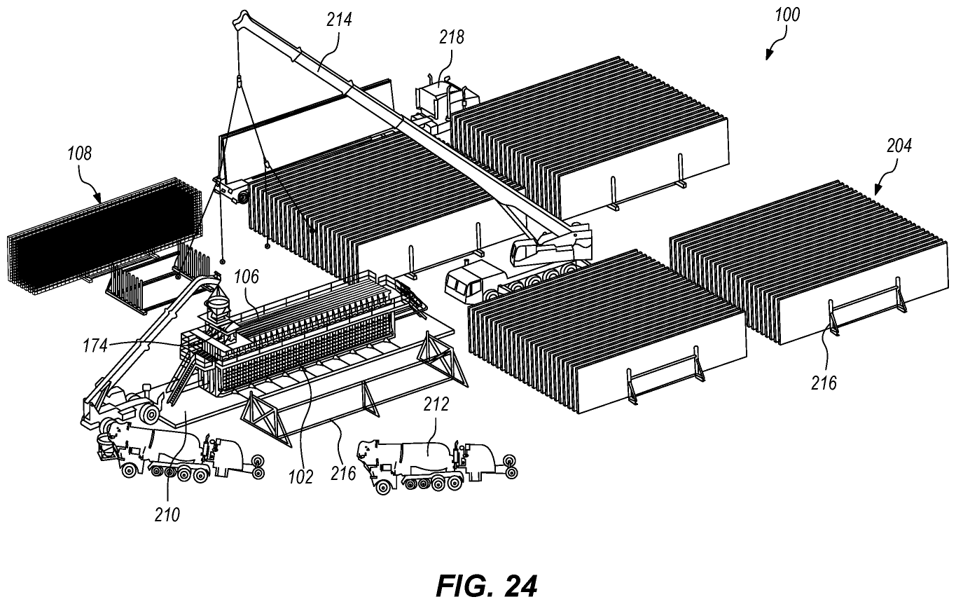

FIG. 24 illustrates a method of use of the panel casting system 100 on the jobsite, according to some embodiments. As shown, the panel casting apparatus 102 has been offloaded from the panel trailer 154 and positioned on a specialized foundation 210 constructed to hold the weight of the panel casting apparatus 102 when filled with dividers 106, concrete receiving inserts 108, and concrete. The foundation 210 provides a firm and even groundwork that prevents settling and other displacement. Concrete trucks 212 standby to mix the concrete and pour it into the concrete hopper 174 to fill and refill it during the concrete casting process. After the concrete wall panels 204 are partially cured, they are lifted by crane 214 (e.g., via the lifting mechanism 206) from the panel casting apparatus 102 into curing racks 216 for complete curing over a period of 24-48 hours or longer. In some embodiments, the curing racks 216 may comprise steel frames with vertical posts to provide staging support to store the concrete wall panels. In other embodiments, the steel frame of the curing racks 216 may comprise a concrete foundation with steel embed pockets for receiving vertical posts to support the concrete wall panels during storage. Said embodiments have the advantage of removing the restriction of aligning the concrete wall panels between posts and risking aesthetic or structural damage prior to installation.

Each of the dividers 106 may further undergo a washing and brushing protocol with application of a form release agent (e.g., diesel oil, wax, silicone, chemically active fatty acids, etc.) to remove any concrete residue and thus improve the smoothness and texture of all concrete surfaces by preventing subsequent adhesion of coatings to the hardened concrete. After the curing phase is completed, the concrete wall panels 204 are again lifted by crane 214 and placed on a semitruck trailer 218 for transportation to the final installation site nearby.

A method of using a panel casting system 100, in some embodiments, comprises assembling concrete receiving inserts 108 offsite at a factory and then transporting the concrete receiving inserts 108 to a jobsite via a trailer 118. Dividers 106 may also be transported to the jobsite via a divider trailer 146 and the panel casting apparatus 102 via the panel trailer 154. The panel casting apparatus 102 may be offloaded from the panel trailer 154 and widened to receive the desired number of dividers 106 so as to form the desired number of wall panels. For example, the concrete receiving inserts 108 and dividers 106 may be inserted alternatingly between the two outer forms 104A-B of the panel casting apparatus 102. The concrete hopper 174 is lifted onto the panel casting apparatus 102 and secured to a conveyor 194. Concrete trucks 212 pump or otherwise pour concrete into the concrete hopper 174. The user actuates a hopper valve 178 and a plurality of dispenser valves 184 to selectively pour the concrete into the concrete receiving inserts 108 between the dividers 106. The conveyor 194 moves the concrete hopper 174 from one end of the panel casting apparatus 102 to the other until all the concrete receiving inserts 108 are filled with concrete. Pairings of chain tensioner brackets 170A-B may be mounted on both the top and the sides of the two outer forms 104A-B of the panel casting apparatus 102 to provide pressure against the concrete receiving inserts 108, while threaded compression rods 164, as previously discussed, provide pressure along the bottom of the concrete receiving inserts 108.

After the concrete has partially cured to a consistency capable of being moved, the crane 214 is coupled to lifting mechanisms 206 along the concrete wall panels 204 whereby the concrete wall panels 204 are lifted away from the dividers 106 in the panel casting apparatus 102 and mounted on curing racks 216 for further curing while the process to this point is repeated. Once the concrete wall panels 204 are fully cured, the crane 214 then lifts them onto a semitruck trailer for transportation to the construction site nearby for final assembly on the façade of a building, according to industry standards.

The disclosure herein for a panel casting system 100 and method of use improves logistical efficiencies throughout the precast concrete wall panel process. The system 100 decreases the costs associated with building warehouses and other large structures which require the casting of concrete wall panels at scale by enabling the casting to occur onsite rather than at distant factories, reducing transportation costs. The onsite casting and curing of concrete wall panels further makes them readily available to accommodate other project scopes and advance the building schedule such that the project is completed faster than other systems currently available. Accordingly, it will be appreciated that the present disclosure solves long-felt, unmet needs in the precast concrete wall industry.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A panel casting system, comprising:
a panel casting apparatus, the panel casting apparatus comprising:
two outer forms,
a plurality of dividers,
a plurality of concrete receiving inserts,
a concrete hopper configured to selectively pour concrete between the plurality of dividers into the plurality of concrete receiving inserts, and a conveyor configured to move the concrete hopper from one side of the panel casting apparatus to the other.

2. The panel casting system of claim 1, wherein each of the plurality of concrete receiving inserts further comprises two side panels coupled to a rebar mesh, hanger plates, and spreaders.

3. The panel casting system of claim 2, wherein each of the plurality of concrete receiving inserts further comprises spring-loaded ties couplable between the rebar mesh and the hanger plates.

4. The panel casting system of claim 2, wherein the spreaders extend bidirectionally along a transverse axis of each concrete receiving insert to maintain adjacent dividers equidistant from one another in the panel casting apparatus.

5. The panel casting system of claim 1, wherein the concrete hopper further comprises a hopper valve, a wall dispenser, a plurality of dispensers, and a plurality of dispenser valves.

6. The panel casting system of claim 1, wherein the panel casting apparatus further comprises a platform and towers couplable to a fall restraint system.

7. The panel casting system of claim 1, wherein the panel casting apparatus further comprises pairings of chain tensioner brackets each coupled to a chain and configured to exert inward pressure against the concrete receiving inserts to facilitate the settling and curing of concrete therein.

8. The panel casting system of claim 1, wherein the panel casting apparatus further comprises threaded compression rods, pivotable base members, and transport stabilizer arms.

9. The panel casting system of claim 1, further comprising a mounting rack or platform configured to move up and down to facilitate assembly of each of the plurality of concrete receiving inserts.

10. A panel casting system, comprising:
a panel casting apparatus, the panel casting apparatus comprising:
two outer forms,
a plurality of dividers interposed between the two outer forms, each divider separated by a respective concrete receiving insert,
a concrete hopper comprising a hopper valve, a wall dispenser, a plurality of dispensers, and a plurality of dispenser valves, the concrete hopper configured to selectively pour concrete between the plurality of dividers into the plurality of concrete receiving inserts,
a conveyor configured to move the concrete hopper from one side of the panel casting apparatus to the other,
a platform surrounding the two outer forms, and
towers extending upwardly from the platform and couplable to a fall restraint system.

11. The panel casting system of claim 10, wherein each of the plurality of concrete receiving inserts further comprises two side panels coupled to a rebar mesh, hanger plates, and spreaders.

12. The panel casting system of claim 11, wherein each of the plurality of concrete receiving inserts further comprises spring-loaded ties couplable between the rebar mesh and the hanger plates.

13. The panel casting system of claim 11, wherein the spreaders extend bidirectionally along a transverse axis of each concrete receiving insert to maintain adjacent dividers equidistant from one another in the panel casting apparatus.

14. The panel casting system of claim 10, wherein the panel casting apparatus further comprises pairings of chain tensioner brackets each coupled to a chain and configured to exert inward pressure against the concrete receiving inserts to facilitate the settling and curing of concrete therein.

15. The panel casting system of claim 10, wherein the panel casting apparatus further comprises threaded compression rods, pivotable base members, and transport stabilizer arms.

16. The panel casting system of claim 10, further comprising a mounting rack or platform configured to move up and down to facilitate assembly of the concrete receiving inserts.

17. A method of using a panel casting system, the method comprising:
assembling a plurality of concrete receiving inserts offsite;
transporting the plurality of concrete receiving inserts from offsite to a jobsite;
transporting a plurality of dividers to the jobsite via a divider trailer;
inserting the plurality of dividers and the plurality of concrete receiving inserts alternatingly between two outer forms of a panel casting apparatus;
selectively pouring concrete from a concrete hopper into the plurality of concrete receiving inserts using a hopper valve and a plurality of dispenser valves;
moving the concrete hopper from one end of the panel casting apparatus to another end via a conveyor;
exerting pressure against the plurality of concrete receiving inserts via pairings of chain tensioner brackets and chains; and
removing partially cured concrete wall panels from the concrete casting apparatus and mounting them to curing racks until completely cured.

18. The method of claim 17, further comprising prior to removing the partially cured concrete wall panels, exerting pressure against the plurality of concrete receiving inserts via threaded compression rods.
